(19) United States
(12) Patent Application Publication
(10) Pub. No.: US 2009/0049272 A1
(43) Pub. Date: Feb. 19, 2009

(54) METHOD FOR IMPROVING THE PERFORMANCE OF SOFTWARE-MANAGED TLB

(75) Inventors: Jose R. Brunheroto, Mohegan Lake, NY (US); Jon K. Kriegel, Rochester, MN (US); Edi Shmueli, Nesher (IL)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/837,929

(22) Filed: Aug. 13, 2007

(51) Int. Cl. G06F 9/34

(52) U.S. Cl. 711/207; 711/E12.002

(57) ABSTRACT

Exemplary embodiments of the present invention comprise a method for the utilization of entry-replacement index hint information within a software-managed TLB. The method comprises receiving an address translation request at a TLB and retrieving the address translation information from a page table in the event of a miss lookup event at the TLB. The method further comprises retrieving index replacement hint information from a hardware component, wherein the hardware component is configured to execute a predetermined replacement algorithm and writing the address translation information to a TLB index referenced within the index replacement hint information.

### BACKGROUND OF THE INVENTION

1. Field of the Invention

This invention relates to translation lookaside buffer management, and particularly to software-managed translation lookaside buffers.

2. Description of Background

The utilization of paged virtual memory simplifies computer programming by giving a process the illusion that it executes in isolation within a large and continuous address space. As such, the address space is internally divided into virtual pages, the virtual pages being mapped into equal-sized physical pages within a system's memory. The mapping from a process's virtual address space into its corresponding physical pages is stored within the system memory at privileged data structures known as page-tables.

A translation-lookaside-buffer (TLB) is a hardware component that caches particular segments of the mappings stored within the page-tables in order to accelerate the translation of virtual addresses during the execution of a program. In its simplest form, a TLB contains a set of entries that duplicate page table information. The information including virtual page numbers and their corresponding physical page numbers in addition to several permission bits. Further, each entry contains a validation bit to indicate whether the information stored in the entry is valid and can be used for translation.

Each virtual address that is generated by a processor triggers a search in a corresponding TLB. In this search, the virtual page number from the processor is compared to the virtual page numbers of all of the TLB entries. An identified match between the virtual page number and a TLB virtual page number entry is known as a TLB hit. In the event that no TLB entries match the virtual page number, or when a match is found but the entry is marked as non-valid, this event is known as a TLB miss.

In the case of a TLB hit, the physical page number is extracted from the matching TLB entry and is used for accessing the physical memory. In the case of a TLB miss, the translation from the virtual page number into the corresponding physical page number needs to be copied from the system page-tables into the TLB. This copying operation can be accomplished using either hardware or software means.

A TLB that is capable of handling misses in hardware is known as hardware managed TLB, whereas a TLB that generate an exception and relies on software to handle a miss is known as a software-managed TLB. In operation, hardware TLBs handle misses efficiently but impose strict restrictions on the format of the system page tables. However, software managed TLBs are simpler to implement than hardware managed TLBs and further allow an increased flexibility in the formatting of data structures that store a translation.

Hardware managed TLBs implement logic that is capable of performing page-table walks, locating translation information, and copying the translation information into the TLB. In comparison, software managed TLBs cause a processor to save the context of the currently executing process and thereafter execute a privileged software routine to handle the miss event. In the most common case, a routine is engaged to perform a page-table walk, locate the translation information, and copy the translation information into a TLB entry.

The improvement of the hit rate of a TLB is necessitated in order to reduce aggregate penalties that are incurred by TLB misses. The hit rate of a TLB is affected by the entry-replacement policy of the TLB, the entry-replacement policy being utilized to determine the TLB entry to replace with the new information from the page tables in the case of a miss. Hardware TLBs typically maintain aging information for the entries in the TLB, the entry aging information being updated on the occurrence of a TLB hit. When a TLB miss occurs, built-in logic within the TLB considers the aging information, and replaces the entry that was least-recently-used, thus resulting in an improved hit rate within the TLB.

### SUMMARY OF THE INVENTION

The shortcomings of the prior art are overcome and additional advantages are provided through the provision of a method for the utilization of entry-replacement index hint information within a software-managed TLB. The method comprises receiving an address translation request at a TLB and retrieving the address translation information from a page table in the event of a miss lookup event at the TLB. The method further comprises retrieving index replacement hint information from a hardware component, wherein the hardware component is configured to execute a predetermined replacement algorithm and writing the address translation information to a TLB index referenced within the index replacement hint information.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a software-managed TLB that is configured to provide entry-replacement hint information from a hardware component in accordance with exemplary embodiments of the present invention.

FIG. 2 is a flow diagram illustrating one example of a software-managed TLB miss event handler in accordance with exemplary embodiments of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Present software-managed TLBs lack a hardware mechanism to maintain aging information since the systems solely rely on software to implement entry-replacement policy operations. Due to the high cost of exceptions, it is impractical to generate an exception on every TLB hit thus allowing the management software to maintain entry aging information. As a result, the management software typically defaults to the implementation of round-robin or random entry-replacement policies, such policies that typically result in lower hit rates for a TLB.

Within exemplary embodiments of the present invention a software-managed TLB is augmented with a means for maintaining index entry-replacement hint information that is maintained at a hardware component. In the event that a TLB miss occurs, the software routine that is handling the miss event can access the hint information at the hardware component and use this information to determine which index entry in a TLB to replace with the new translation that has been provided by the page tables.

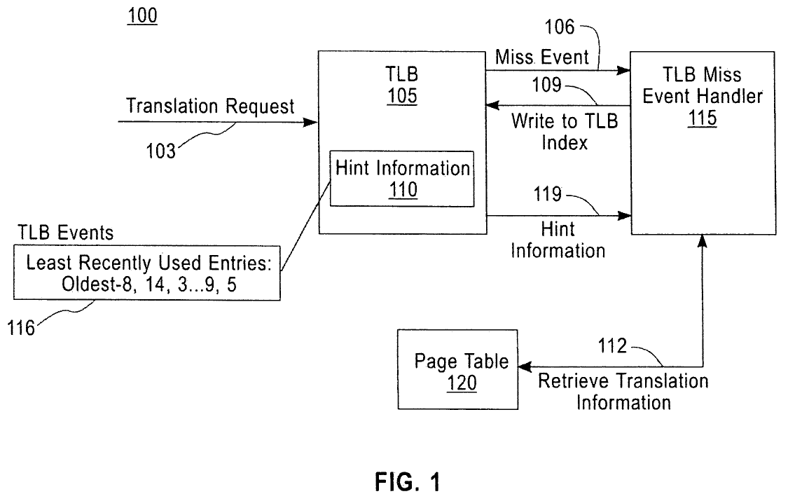

FIG. 1 illustrates aspects of a software-managed TLB system 100 comprising a TLB 105, a TLB index entry-replacement hint information component 110, a TLB miss event handler 115, and a page table 120. As shown, the software-managed TLB 105 is augmented with a means for maintaining entry-replacement hint information. Within this exemplary embodiment the TLB entry-replacement hint information component 110 maintains aging information for the entries that are stored within the TLB 105. The TLB index entry-replacement hint information component 110 as shown is embedded within the software managed TLB 105. However, within further exemplary embodiments the TLB index entry-replacement hint information component 110 can comprise a stand-alone information storage unit.

In operation, a request for an address translation 103 is received at the TLB 105, where in the event that a physical address match is identified a hit event is generated. The hit event is reported to the TLB index entry-replacement hint information component 110, wherein the TLB hit event information 116 is stored at the TLB index entry-replacement hint information component 110. In the instance of a miss event 109, the miss event 106 initiates the execution of the TLB miss event handler 115. The TLB miss event handler 115 is a software routine that retrieves 112 the requested address translation 103 from the page table 120. Once the address translation information has been retrieved from the page table 120, the TLB miss event handler 115 makes a determination to use or not use the TLB index entry-replacement hint information in order to determine a replacement index value. In the instance that the TLB miss event handler 115 determines that the TLB index entry-replacement hint information will not be used, then any default software replacement algorithm that is provided within the TLB software management program can be implemented to identify a TLB index to which to write that requested translation address (e.g., the round-robin replacement policy as described above).

In the instance that the miss event handler 115 determines that the TLB index entry-replacement hint information will be utilized, then the miss event handler 115 will issue a query for the replacement index information from the TLB entry-replacement hint information component 110 (e.g., by using a tlbhint instruction). As a result of receiving the query request, the TLB entry-replacement hint information component 110 will provide (119) the replacement index information to the TLB miss event handler 115, and thereafter the index entry-replacement hint information is used to point to the index that the retrieved translation information will be written to at the TLB 105.

Within exemplary embodiments of the present invention the TLB index entry-replacement hint information component 110 can comprise a hardware TLB, wherein the hardware TLB is configured to execute a replacement algorithm (e.g., a least recently used (LRU), a most frequently used (MRU), a least frequently used (LFU), etc.) for the management of replaced index entries. For the present exemplary examples we assume that the TLB index entry-replacement hint information component 110 is configured to utilize a LRU based replacement algorithm. In general, the TLB index entry-replacement hint information component's 110 LRU mechanisms are generally only needed when some form of hardware initiates the replacement of aging entries (e.g., as is in the case for a hardware table walking operation).

Another common application for LRU enhanced hardware is in the event that a form of “shadow” TLB cache is implemented in order to increase performance for instruction fetch translation and/or data load/store translations. The “shadow” TLB(s) are generally reloaded via a hardware LRU mechanism, with the underlying software-managed ILB providing data for the updates. When it is desirable to provide for both hardware and software replacement in the same TLB hardware structure, the LRU hardware logic (which is generally present already) can be exploited to also provide aging information to TLB management software. Alternately, hardware LRU logic can be intentionally added to software managed TLB circuits that would otherwise not require such logic.

TLB events that are important for the purpose of maintaining the aging information (e.g., such as TLB hits) are communicated to the TLB index entry-replacement hint information component 110, wherein the aging information is accordingly updated in conjunction with each event occurrence. For example, if index entry 9 in the TLB 105 was recently hit and now index entry 5 is hit by a subsequent memory reference, a TLB hit event carrying the index 5 is communicated to the TLB index entry-replacement hint information component 110. The TLB index entry-replacement hint information component 110 updates the aging information TLB event information 116 so that index entry 9 becomes the second recently hit entry and index entry 5 becomes the most recently hit entry. In this example, the TLB index entry-replacement hint information component 110 maintains the indexes of the entries in a priority list. As such, the least recently hit entry (oldest) the highest priority and the most recently hit entry the lowest priority.

In further exemplary embodiments of the present invention the TLB index entry-replacement hint information component 110 can also prioritize invalid entries over valid entries, even in the event that an invalid entry has been hit more recently than a valid entry. For example, if index entry 14 is the least, recently hit entry in the TLB 105 and the operating system invalidates index entry 8, a TLB invalidate event carrying the index 8 is delivered to the TLB index entry-replacement hint information component 110. As a result, the TLB index entry-replacement hint information component 110 updates its priority list so that index entry 8 has the highest priority entry in the TLB event information listing 113 and entry 14 has the second highest priority entry.

In the event that a TLB miss occurs, the TLB miss event handler 115 that is handling the miss can access the hint information that is maintained by the TLB index entry-replacement hint information component 110, and use that information to decide which entry in the TLB 105 to replace with the new translation from the page table 120. The information can be provided through a new instruction that is added to the processor standard ISA (e.g., such as tlbhint) or a modification to an existing instruction which is already part of the processor standard ISA (e.g., such as tlbre).

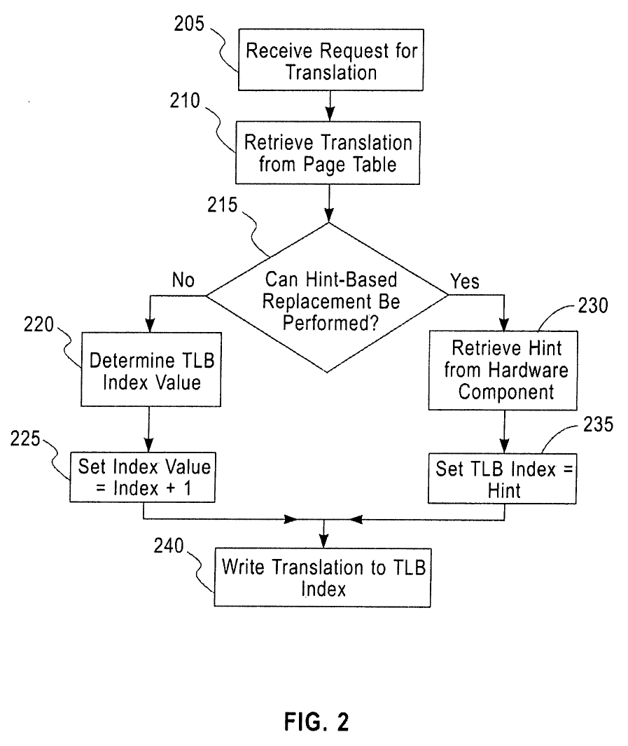

FIG. 2 shows a flow diagram for method for the utilization of entry-replacement index hint information within a software-managed TLB. At step 205 an address translation request is received at a TLB 105. In the event of a miss event at the TLB 105, at step 210, the address translation information is retrieved from a page table 120 by the TLB miss event handler 115. At step 215 a determination is made by the TLB miss event handler 115 to determine if index replacement hint information can be utilized to identify a TLB entry index. In the event that TLB index entry-replacement hint information can be utilized, then at step 230 an index replacement hint is retrieved from a TLB index entry-replacement hint information component 110, wherein the TLB index entry-replacement hint information component 110 is configured to execute a predetermined replacement algorithm. At step 235 the TLB entry-replacement hint information is set as the TLB index value.

In the event that it is determined that index replacement information cannot be used to identify a TLB entry index then a secondary default software replacement algorithm is implemented in order to identify a TLB index. At step 220 the TLB index entry is set to a replacement index value (step 225). The replacement index value comprises a last TLB entry index that is incremented by a count of 1, wherein if the TLB entry index is equal to a predetermined value, then the TLB entry index is set equal to 0. Lastly, at step 240, the address translation information is written to the TLB index that has been referenced within the index replacement hint information or the replacement index.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the utilization of entry-replacement index hint information within a software-managed translation lookaside buffer (TLB), the method comprising:
receiving an address translation request at a TLB;
retrieving the address translation information from a page table in the event of a miss lookup event at the TLB;
retrieving index replacement hint information from a hardware component, wherein the hardware component is configured to execute a predetermined replacement algorithm; and
writing the address translation information to a TLB index referenced within the index replacement hint information.

2. The method of claim 1, wherein the index replacement hint information comprises the index of the highest priority entry of an entry priority list that is maintained at the hardware component.

3. The method of claim 1, wherein the indexes of invalid entries comprised within an entry priority list that is maintained at the hardware component have priority over the indexes of valid entries.

4. A computer program product that includes a computer readable medium useable by a processor, the medium having stored thereon a sequence of instructions which, when executed by the processor, causes the processor to determine entry-replacement index information for utilization within a software-managed translation lookaside buffer (TLB), by:
receiving an address translation request at a TLB;
retrieving the address translation information from a page table in the event of a miss lookup event at the TLB;
determining if index replacement hint information can be utilized to identify a TLB index;
retrieving index replacement hint information from a hardware component, wherein the hardware component is configured to execute a predetermined replacement algorithm in the event that it is determined that index replacement hint information can be utilized to identify the TLB index; and
writing the address translation information to the TLB index referenced within the index replacement hint information.

5. The computer program product of claim 4, where in the event that it is determined that index replacement information cannot be used to identify a TLB index then the TLB index is identified by a secondary software replacement algorithm.

6. The computer program product of claim 5, further comprising writing the address translation information to the replacement index.
